(19) United States
(12) Patent Application Publication
(10) Pub. No.: US 2008/0011279 A1
(43) Pub. Date: Jan. 17, 2008

(54) SPARK IGNITION TYPE MULTI-CYLINDER ENGINE

(75) Inventor: Hiromitsu Matsumoto, Shizuoka-ken (JP)

Correspondence Address: KNOBBE MARTENS OLSON & BEAR LLP, 2040 MAIN STREET, FOURTEENTH FLOOR, IRVINE, CA, 92614, US

(73) Assignee: YAMAHA HATSUDOKI KABUSHIKI KAISHA, Shizuoka-ken (JP)

(21) Appl. No.: 11/774,355

(22) Filed: Jul. 6, 2007

(30) Foreign Application Priority Data
Jul. 7, 2006 (JP) 2006-187633

(51) Int. Cl. F02M 25/07

(52) U.S. Cl. 123/568.11

(57) ABSTRACT

An engine has an intake device such that intake air passed through an entrance passage having a throttle valve is distributed to an intake passage of each cylinder. The engine has an EGR device such that exhaust gas is led to an intake system via an EGR valve to improve fuel efficiency over the entire operational range of the engine and results in a reduction in manufacturing costs. The respective intake passage of each cylinder has a main intake passage provided with an intake control valve, and a plurality of auxiliary intake passages along this main intake passage for generating a swirl of air charge inside the combustion chamber. A venturi tube is provided on a downstream side of the throttle valve of the entrance passage. An exhaust gas exit of the EGR device is formed on an internal wall surface of the venturi tube. A reed valve is provided between this exhaust gas exit and the EGR valve.

### CROSS-REFERENCE TO RELATED APPLICATIONS

The present application is based on and claims priority under 35 U.S.C. §119 to Japanese Patent Application No. 2006-187633, filed on Jul. 7, 2006, the entire contents of which are expressly incorporated by reference herein.

### BACKGROUND OF THE INVENTION

1. Field of the Invention

The present invention relates to a spark ignition type multi-cylinder engine using an exhaust gas recirculation device to improve fuel efficiency.

2. Description of the Related Art

A conventional spark ignition type engine that improves fuel efficiency using an exhaust gas recirculation device (hereinafter simply referred to as “EGR device”) is disclosed in Japanese Publication No. JP 05-086945.

The conventional engine shown in FIG. 17 of JP 05-086945 is a V-type six-cylinder engine, which includes two intake valves and two exhaust valves per cylinder, a valve operating system for driving these intake and exhaust valves via an intake camshaft and an exhaust camshaft, a variable valve timing mechanism for individually changing phases between the intake camshaft and the exhaust camshaft, and an intake device for distributing intake air measured by a throttle valve to each cylinder.

In this conventional engine, internal EGR is performed having an overlap amount between the intake and exhaust valves, in addition to external EGR in low or medium load oeration, and pumping loss is reduced by delaying a timing at which the exhaust valve closes. Thereby, fuel efficiency is improved. The variable valve timing mechanism is used for adjusting an overlap amount and delaying a timing at which the exhaust valve closes. Also, in this engine, an air-fuel ratio of a fuel is set to the theoretical air-fuel ratio in a high load operation, and thereby fuel efficiency is improved. A combustion temperature rises due to the air-fuel ratio setting to the theoretical air-fuel ratio in high load operation. However, exhaust gas is led into an intake passage by the external EGR in high load operation, and thereby a combustion temperature is lowered.

An external EGR device provided in a conventional general spark ignition type engine has an EGR valve provided in an EGR gas passage communicatively connecting an inside of an exhaust passage of an exhaust pipe and an inside of an intake passage on a downstream side of a throttle valve. In this kind of EGR device, a negative pressure in the exhaust passage is lowered in high load operation where a throttle opening is large, and thus EGR gas (exhaust gas) is not easily inducted into the exhaust passage. Therefore, a proportion of EGR gas to a whole amount of gas in the exhaust passage, namely an EGR rate, decreases. An EGR rate (%) is calculated as {EGR gas amount/(fresh gas amount+EGR gas amount)}×100.

Japanese Publication No. JP 2000-249004 discloses a conventional EGR device where a large amount of EGR gas can be inducted into an intake passage in a high load operation. The EGR device described in JP 2000-249004 is provided on a diesel engine and has a construction such that EGR gas is drawn into the intake passage using a venturi tube provided in the intake passage. An EGR gas exit of this EGR device is formed on an internal wall surface of this venturi tube. In this EGR device for a diesel engine, a reed valve is provided between the EGR gas exit and an EGR valve for preventing a flow of intake air into an exhaust passage due to a pressure difference between the intake passage and the exhaust passage. In addition, a throttle valve is not provided because the engine having this EGR device is a diesel engine.

In the engine shown in JP 05-086945, an overlap amount is increased using a variable valve timing mechanism in low and medium load operation to increase the internal EGR. Thereby, fuel efficiency is improved. A cost for producing this engine is high because a variable valve timing mechanism is expensive. Also, a negative pressure is lowered in high load operation, as mentioned above, and an amount of EGR gas is insufficient. Thus, there is a limit on combustion temperature control. Therefore, it is difficult to improve fuel efficiency by having a higher compression ratio due to knocking.

An EGR device disclosed in JP 2000-249004 is used for a diesel engine in which a throttle valve is not used, and it cannot be simply diverted to a spark ignition type engine.

### SUMMARY OF THE INVENTION

In view of the circumstances noted above, an aspect of at least one of the embodiments disclosed herein is to provide an engine such that fuel efficiency is improved over almost the entire operation range and a manufacturing cost can be reduced.

In accordance with one aspect of the invention, a spark ignition type multi-cylinder engine is provided. The engine comprises an intake device configured to distribute intake air through an entrance passage having a throttle valve to an intake passage of at least one cylinder of the engine. The engine also comprises an exhaust gas recirculation device configured to recirculate exhaust gas to an intake system via an exhaust gas recirculation valve, wherein each intake passage of each cylinder comprises a main intake passage connected to a combustion chamber via an intake valve and comprising an intake control valve therein in an upstream position, and a plurality of auxiliary intake passages configured to generate a swirl (tumble) of air charge inside the combustion chamber, each auxiliary intake passage extending along the main intake passage and having an inlet opening upstream of the intake control valve and an outlet opening at a downstream end thereof proximate the intake valve in the main intake passage. The engine also comprises a venturi tube disposed on a downstream side of the throttle valve in the entrance passage, an exhaust gas exit of the exhaust gas recirculation device being formed on an internal wall surface of the venturi tube, and a check valve provided between the exhaust gas exit and the exhaust gas recirculation valve.

In accordance with another aspect of the present invention, a spark ignition type multi-cylinder engine is provided. The engine comprises an intake air conduit configured to distribute intake air to an intake passage of at least one cylinder of the engine, the intake passage comprising a primary intake passage having an intake control valve therein, the primary intake passage in communication with a combustion chamber of the cylinder via an intake valve, the intake passage further comprising at least one auxiliary intake passage configured to generate a swirl of air charge inside the combustion chamber, the auxiliary intake passage having an inlet opening upstream of the intake control valve and an outlet opening proximate the intake valve in the primary intake passage. The engine also comprises an exhaust gas recirculation device configured to recirculate at least a portion of exhaust gas to the intake passage of the at least one cylinder of the engine, and a venturi tube coupled to the air intake conduit, the exhaust gas recirculation device coupled to the venturi tube via a reed valve disposed between the exhaust gas recirculation device and the venture tube.

In accordance with yet another aspect of the present invention, a method for operating a spark ignition type multi-cylinder engine is provided. The method comprises distributing intake air to at least one cylinder of the engine, recirculating at least a portion of exhaust gas into combination with the intake air directed to the at least one cylinder, and controlling an exhaust gas recirculation (EGR) valve to control the amount of recirculated exhaust gas directed to the at least one cylinder to obtain an EGR rate in response to an operating state of the engine.

### BRIEF DESCRIPTION OF THE DRAWINGS

These and other features, aspects and advantages of the present inventions will now be described in connection with preferred embodiments, in reference to the accompanying drawings. The illustrated embodiments, however, are merely examples and are not intended to limit the inventions. The drawings include the following 6 figures.

FIG. 1 is a schematic block diagram of a spark ignition type multi-cylinder engine in accordance with one embodiment.

FIG. 2 is an enlarged cross-sectional schematic view showing a part of the spark ignition type multi-cylinder.

FIG. 3 is a schematic view of an intake system.

FIG. 4 is a schematic bottom plan view of a cylinder head.

FIG. 5 is a schematic cross-sectional view of a venturi taken along a line V-V in FIG. 2.

FIG. 6 is a graph illustrating an example of a map for setting an opening of an EGR valve.

### DETAILED DESCRIPTION OF THE PREFERRED EMBODIMENT

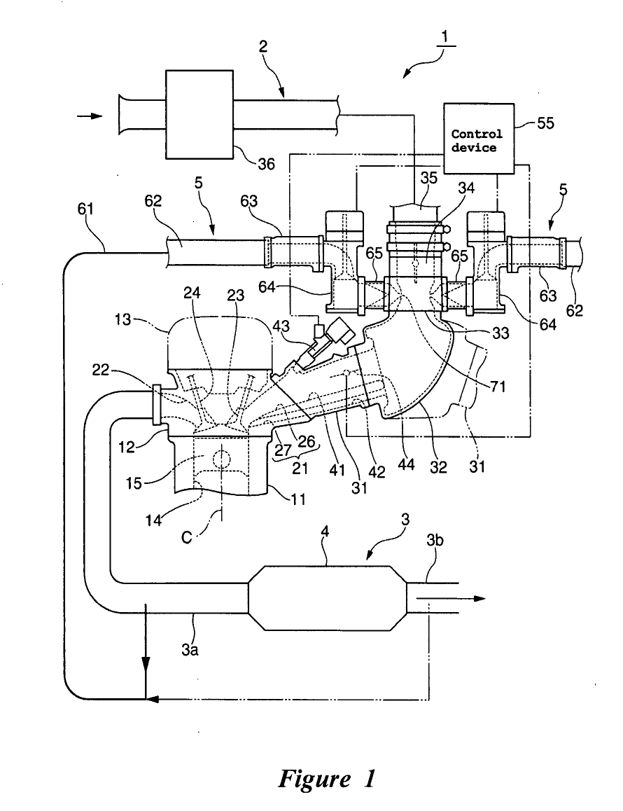

FIG. 1 shows a spark ignition type multi-cylinder engine 1 according to one embodiment. The engine 1 can be a four-cycle V-type eight-cylinder engine. Because knocking does not easily occur in this engine, as described below, this engine is formed with a higher compression ratio compared with a conventional V-type eight-cylinder engine.

An intake device 2 (see FIG. 1) is connected to a side of each of two cylinder columns of the engine 1, on which the two cylinder columns face each other (hereinafter simply referred to as “side part inside a V-bank”). An exhaust device 3 is connected to an opposite side. The exhaust device 3 has a catalytic converter 4, which can be a three-way catalyst. Also, an exhaust gas recirculation device (hereinafter simply referred to as “EGR device”) 5 is connected to the exhaust device 3 and intake device 2.

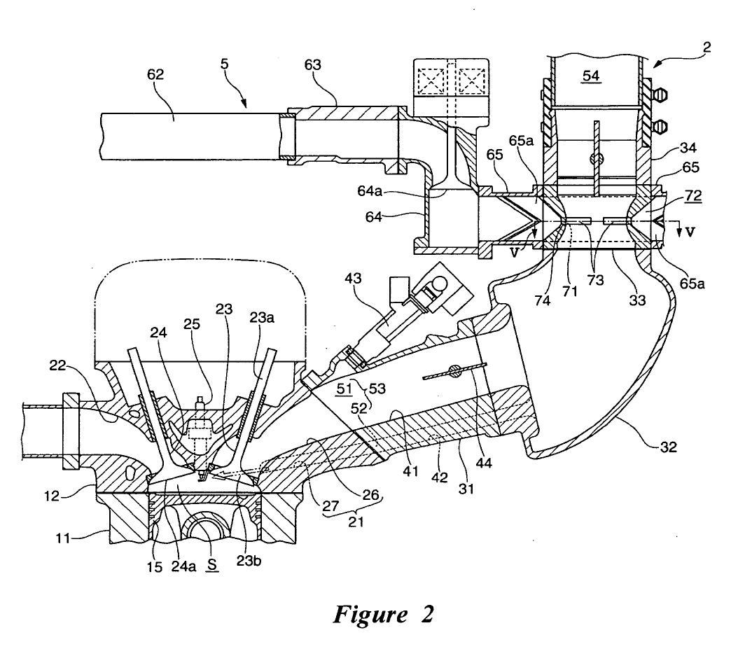

As shown in FIG. 1, each cylinder column of the engine 1 has a cylinder block 11, a cylinder head 12 mounted on the cylinder block 11, a head cover 13 mounted on the cylinder head 12, and so forth. In FIG. 1 and FIG. 2, a reference numeral 14 denotes a cylinder bore of the cylinder block 11, a reference numeral 15 denotes a piston, and a one-dot chain line C indicates an axis of the cylinder.

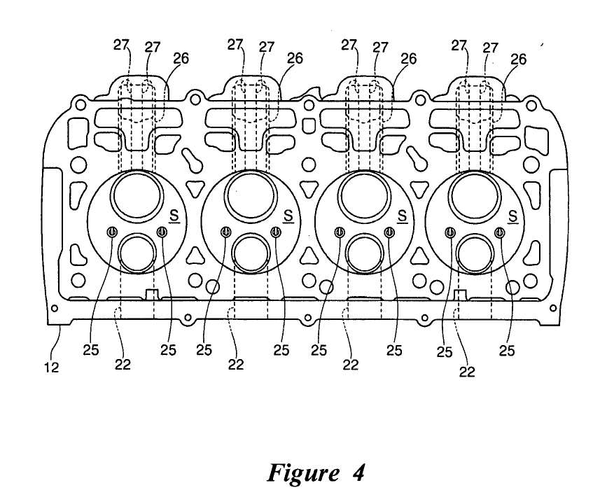

As shown in FIG. 2 and FIG. 4, cylinder head 12 is provided with an intake port 21 and an exhaust port 22 formed on each cylinder; an intake valve 23 and an exhaust valve 24 for opening and closing these ports 21 and 22; and two ignition plugs 25 for each cylinder. Although not shown, an overhead valve (OHV) type valve operating system can be used for driving the intake valve 23 and exhaust valve 24 to reduce cost.

The intake port 21 constructs a part of the intake passage of each cylinder. The intake port 21 can be constructed with a main intake port 26 formed such that a cross-sectional area of the passage is relatively large, two auxiliary intake ports 27 formed parallel to the main intake port 26 and having relatively small cross-sectional areas, and so forth.

The main intake port 26 is connected to a combustion chamber S via an intake valve 23, and formed to extend from the combustion chamber S to the side part inside the V-bank of the cylinder head 12. A downstream end of the auxiliary intake port 27 opens proximate the intake valve 23 of the main intake port 26 and on a side opposite to a part where a valve stem 23a of the intake valve 23 of the main intake port 26 penetrates. The auxiliary intake port 27 can be formed such that it extends from the downstream end to the side part inside the V-bank of the cylinder head 12. The two auxiliary intake ports 27, 27 are formed such that two passage ports parallel to each other are drilled into the cylinder head 12 (See FIG. 4).

As shown in FIG. 4, the main intake port 26 and the auxiliary intake port 27 can be formed such that they extend linearly from the combustion chamber S toward the side part of the cylinder head 12 (the side part inside the V-bank) viewed from the axis direction of the cylinder. As shown in FIG. 2, the two auxiliary intake ports 27, 27 can be formed in a position such that they are below the main intake port 26 (at the cylinder block 11 side) viewed from the axis direction of a crankshaft (not shown) while being almost parallel to the main intake port 26 and overlap with the main intake port 26 viewed from the axis direction of the cylinder as shown in FIG. 4.

Also, as shown in FIG. 2, the two auxiliary intake ports 27, 27 can be formed in a position such that they overlap with each other viewing from the axis direction of the crankshaft, and, as in FIG. 4, formed such that they are parallel to each other at a distance viewed from the axis direction of the cylinder. That is, the auxiliary intake ports 27, 27 can be formed below both sides of the main intake port 26.

Further, as shown in FIG. 2, these two auxiliary intake ports 27, 27 can be formed in the cylinder head 12 at an angle such that an imaginary extension line extending from the auxiliary intake ports 27 extends to the combustion chamber and contacts a valve body bottom surface 24a of the exhaust valve 24 or a peripheral wall of the combustion chamber S. Although not shown, an angle at which the auxiliary intake ports 27, 27 can be formed can also be an angle such that the imaginary extension line extending from the auxiliary intake ports 27 contacts an upper peripheral wall of a cylinder bore 14.

As foregoing, the auxiliary intake port 27 can be formed horizontally or slightly slanted along the main intake port 26. Thereby, intake air flowing out from the auxiliary intake port 27 passes through both the sides of the valve stem 23a of the opened intake valve 23, then passes through a part between a valve body 23b and an opening at a downstream end of the intake port 21, and flows into the combustion chamber S.

A swirl of air charge is generated inside the cylinder because of a flow of a large amount of intake air through the auxiliary intake port 27. This swirl of air charge generates in a state having a prescribed width in the axis direction of the crankshaft because the two auxiliary intake ports 27 are aligned in the axial direction of the crankshaft. The two ignition plugs 25, 25 are mounted on the cylinder head 12 aligned in the, axial direction of crankshaft so that fuel is certainly ignited although a width of a swirl of air is large (see FIG. 4).

As shown in FIG. 1 and FIG. 2, the intake device 2 for leading intake air into the main intake port 26 and auxiliary intake port 27 can be constructed with an intake manifold 31 of each cylinder column connected to one side part of the cylinder 12 (the side part inside the V-bank), a surge tank 32 connected to an upstream end of the intake manifold 31, a throttle valve 34 connected to the surge tank 32 via a venturi member 33 described further below, and an air cleaner 36 connected to an upstream end of the throttle valve 34 via an intake pipe 35.

The intake manifold 31 can be provided on each cylinder column, and provided with a main intake path 41 connected to the main intake port 26, two auxiliary intake paths 42, 42 connected to the auxiliary intake ports 27, a fuel injector 43, and an intake control valve 44 described below. The main intake path 41, two auxiliary intake paths 42, 42, fuel injector 43, and intake control valve 44 can be provided in each cylinder.

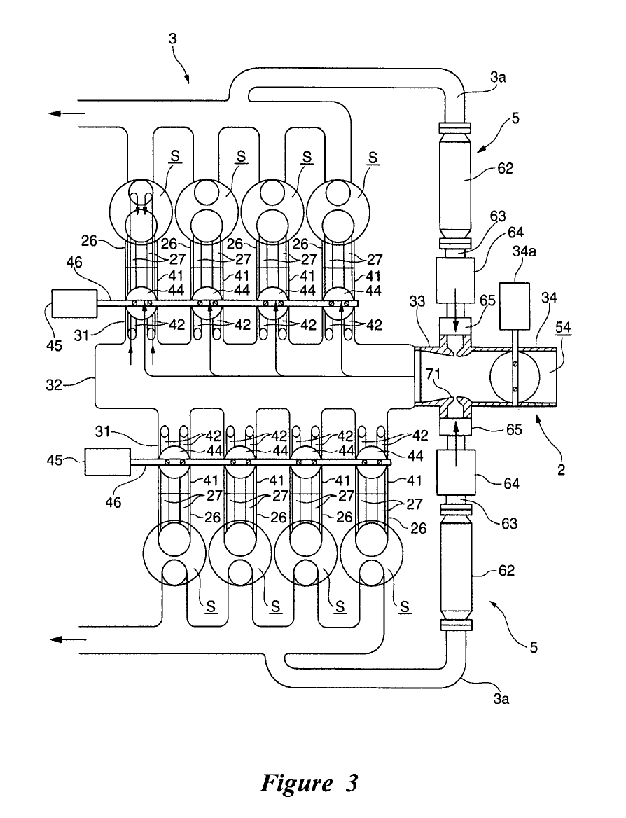

The main intake path 41 and the auxiliary intake paths 42 can be formed such that they individually penetrate the intake manifold 31. The two auxiliary intake paths 42 can be formed such that they overlap with each other viewed from the axis direction of the crankshaft, as shown in FIG. 2, and can be parallel to each other viewed from the axis direction of the cylinder as shown in FIG. 3 and FIG. 4.

As shown in FIG. 2, a main intake passage 51 can be formed with the main intake path 41 and the main intake port 26, and an auxiliary intake passage 52 can be formed with the auxiliary intake path 42 and the auxiliary intake port 27, in the engine 1. Also, an intake passage 53 of each cylinder can be constructed with the main intake passage 51 and the auxiliary intake passage 52 in this embodiment.

The fuel injector 43 can be mounted above a downstream end of the main intake path 41 of the intake manifold 31, and injects fuel from an upper part inside the main intake path 41. A fuel injection amount of the fuel injector 43 can be set and controlled by a controller 55, as shown in FIG. 1. The fuel injector 43 supplies fuel over almost the entire operation range of the engine 1 in the theoretical air-fuel ratio. However, there is a case where an exhaust temperature is lowered by changing the air-fuel ratio to the rich side to protect a catalyst in high speed and high load operation. In this embodiment, a fuel supply device can be constructed with this fuel injector 43 and the controller 55.

The intake control valve 44 for opening or closing the intake passage 51 can be provided inside an upstream end of the main intake path 41. This intake control valve 44 can be a butterfly valve and opened or closed by the operation of a motor 45 (see FIG. 3) connected to the controller 55. In the intake control valve 44 according to this embodiment, the controller 55 can control the operation of the motor 45 by, for example, following a map previously obtained by experiment. Thereby, the intake control valve 44 can be continuously controlled to an optimum opening in response to an operation state of the engine.

Most intake air flows into the combustion chamber S through the auxiliary intake passage 52 when the intake control valve 44 is closed. In addition, the controller 55 may be a control device that controls simply by turning on and off the intake control valve 44.

As shown in FIG. 3, the intake control valves 44 of each cylinder can be connected to a valve stem 46 penetrating the intake manifold 31 in a manner that the intake control valves 44 are interlocked with each other.

The surge tank 32 can be formed into a shape such that it extends in the axial direction of the crankshaft. The intake manifold 31 of each cylinder column is respectively connected to one side or the other side of the surge tank 32. As shown in FIG. 3, this surge tank 32 distributes intake air flow from the throttle valve 34 to the intake passage 53 of each cylinder of each intake manifold 31. In addition, FIG. 2 shows the intake manifold 31 of one side mounted on the surge tank 32. However, the intake manifold 31 of the other side is also mounted on the surge tank 32 as shown by a chain double-dashed line in FIG. 1. An entrance passage 54 is constructed with the intake passage upstream of the surge tank 32.

The venturi member 33 can form the intake passage between the surge tank 32 and the throttle valve 34. EGR gas is drawn from the EGR device 5 mentioned below into the intake passage (entrance passage 54) at least in part by a pressure difference. FIG. 3 shows one embodiment where the venturi member 33 and the throttle valve 34 are formed into one body. However, these members can be formed as separate bodies and assembled together as shown in FIG. 2.

The throttle valve 34 can be a butterfly valve, which can be manually controlled. In addition, to manually control the throttle valve 34, the throttle valve 34 can be constructed such that a driving motor 34a is connected to the throttle valve 34 and an the motor 34a is operated by an amount to manually increase or decrease the throttle valve 34 opening.

As shown in FIG. 1, the EGR device 5 connected to the venturi member 33 can include an EGR gas cooler 62 connected to the exhaust device 3 by an EGR gas pipe 61, an EGR valve 64 (exhaust gas recirculation valve) connected to the EGR gas cooler 62 via a connecting pipe 63, a reed valve 65 interposed between the EGR valve 64 and the venturi member 33, and so forth.

The EGR gas pipe 61 can be connected to an exhaust pipe 3a positioned upstream of the catalytic converter 4 of the exhaust device 3. In addition, the EGR gas pipe 61 can be connected to an exhaust pipe 3b positioned downstream of the catalytic converter 4 as shown by a chain double-dashed line in FIG. 1.

The EGR gas cooler 62 cools EGR gas passing therethrough.

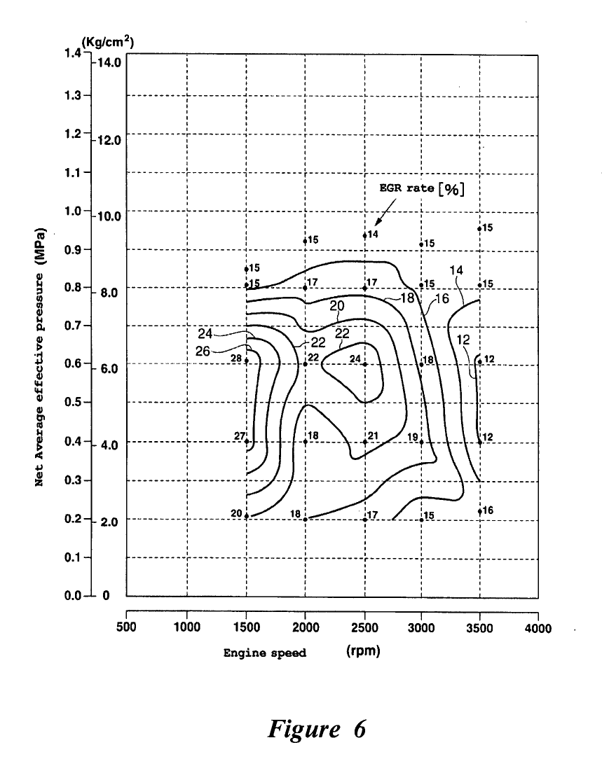

The EGR valve 64 can be an electric type poppet valve. An opening position of a valve body 64a can be continuously controlled by the controller 55. Thereby, the EGR valve 64 can switch between circulating and stopping EGR gas flow and adjust an amount of EGR gas flow. An opening of this EGR valve 64 can be controlled by the controller 55 so that an EGR rate can be obtained in response to an operation state of the engine. This EGR rate can be obtained from a map, such as the map shown in FIG. 6.

A map shown in FIG. 6 is formed by plotting EGR rates in engine speed (horizontal axis) and net average effective pressure (vertical axis), and can be stored in a memory (not shown) in the controller 55. A net average effective pressure is equivalent to the level of a load of the engine 1, and it can be obtained by calculation of, for example, an engine speed and an amount of introduced air.

A dot shown in FIG. 6 shows the EGR rate corresponding to an engine speed and a net average effective pressure. Also, a curve shown in FIG. 6 joins the dots of the same EGR rate in a so-called contour line shape. An EGR rate is set to gradually change between adjoining curves in FIG. 6. For example, an EGR rate increases or decreases between 18% and 20% responding to an increase or decrease in an operating condition of the engine (engine speed and net average effective pressure) in an area between a curve showing the EGR rate 20% and a curve showing the EGR rate 18%.

As shown by FIG. 6, an EGR rate of 28%, which is the maximum, is achieved in a medium load and low revolution state, and an EGR rate of 24% is achieved in a medium load and medium revolution state of the engine 1. Also, FIG. 6 shows that the EGR valve 64 opens in the engine 1 so that an EGR rate is 15% in an engine operation state (high load operation state) where a net average effective pressure is the greatest.

Also, the operation (e.g., opening) of the EGR valve 64 can be controlled by the controller 55 where a negative pressure downstream of the reed valve 65 sharply decreases from a state of high negative pressure. The EGR valve 64 opens where an operation state of the engine 1 is switched from a low-load state to a high-load state in a short period, and where the engine 1 operating in a low-load state stops.

The reed valve 65 opens when EGR gas is drawn into the intake passage 54, and inhibits intake air from flowing from the intake passage 54 to the EGR valve 64. This reed valve 65 can be a check valve.

The EGR device 5 is provided on each cylinder column, namely, on each of a left and right banks, and individually connected to one side and the other side of the venturi member 33 (See FIG. 1). Only one of the EGR devices 5 connected to one cylinder column is shown in FIG. 2. Also, in this embodiment, the EGR device 5 is constructed such that the EGR valve 64 and the reed valve 65 of one EGR device 5, and the EGR valve 64 and the reed valve 65 of the other EGR device 5 are fixed to the venturi member 33 in an integrated manner, and thereby a distance between both the EGR valves 64 and the intake passage (entrance passage 54) is as short as possible. With this structure, an amount of EGR gas allowed into the intake passage 54 changes accurately responding to opening or closing of the EGR valve 64.

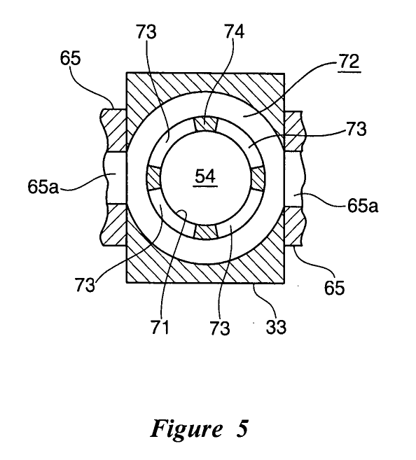

As shown in FIG. 2 and FIG. 5, a venturi tube 71 and a gas chamber 72 having an annular cross-section and enclosing around a periphery of this venturi tube 71 are formed inside the venturi member 33. The venturi tube 71 can be constructed such that a cross-sectional area of the passage of the intake passage 54 is partly formed small.

The gas chamber 72 can be opened to the outside of the venturi member 33 via openings at two sides where the reed valves 65 are mounted, and connected to an inside of a downstream part 65a of the reed valve 65 mounted on the venturi member 33 as covering these openings. Also, an inner periphery of the gas chamber 72 is connected to an inside of the exhaust passage (entrance passage 54) via at least one slit 73 opening on an internal wall surface of the venturi tube 71.

As shown in FIG. 5, the slit 73 can be formed such that it penetrates an internal wall 74 having an annular cross section, which defines the gas chamber 72 and the intake passage (entrance passage 54), in the thickness direction. Also, the slit 73 can be formed at four sections along the circumference of the internal wall 74. That is, the intake passage (entrance passage 54) is in communication with the inside of the downstream part 65a of the reed valve 65 via the slits 73 at the four parts and the gas chamber 72. Therefore, according to this embodiment, the slit 73 provides an EGR gas exit (exhaust gas exit) of the EGR device 5.

With the engine 1 constructed as foregoing, a negative pressure occurring inside the intake passage (entrance passage 54) downstream of the throttle valve 34 is transmitted to the EGR device 5 via the venturi member 33. In a state where the EGR valve 64 is open, EGR gas is drawn into the intake passage due to a pressure difference between an inside of the intake passage and an inside of an exhaust passage of the exhaust pipe 3a. EGR gas drawn from the EGR device 5 into the intake passage is cooled down by the EGR gas cooler 62 and its temperature is lowered.

A pressure is kept negative inside the venturi tube 71 of the venturi member 33 because of a high speed flow of intake air even when the throttle valve 34 opens widely and the negative pressure decreases.

Therefore, in the engine 1 according to this embodiment, EGR gas is led into the intake passage (entrance passage 54) by the EGR device 5 during a high load operation such that an opening of the throttle valve 34 is relatively large, and thereby an EGR rate is improved. EGR gas drawn into the entrance passage 54 and fresh air is distributed from the surge tank 32 to the intake passage 53 of each cylinder, and drawn into the combustion chamber S of each cylinder.

A combustion temperature is lowered in the engine 1 because EGR gas is drawn into the combustion chamber S. Generally, knocking does not easily occur in an engine if a combustion temperature is lowered. Therefore, because a combustion temperature can be lowered with the improvement of an EGR rate in a high load operation of the engine 1 according to this embodiment, a compression ratio can be set high compared with general V-type eight-cylinder engines, while preventing engine knock.

As a result of setting a high compression ratio, thermal efficiency is high and fuel efficiency is improved during high load operation of the engine 1 according to this embodiment. The air-fuel ratio of the fuel for the engine 1 is determined as a theoretical air-fuel ratio, and therefore hazardous constituents in the exhaust gas are purified when the exhaust gas passes through the catalytic converter 4.

On the other hand, in the engine 1 according to this embodiment, an opening of the intake valve control 44 is reduced in low or medium load operation, and intake air flows from the surge tank 32 mainly into the auxiliary intake passage 52 (auxiliary intake port 27 and auxiliary intake path 42). In this engine 1, an amount of intake air passing through the auxiliary intake passage 52 increases, and thereby a swirl of air charge is generated in the cylinder. Therefore, combustion is stabilized in low or medium load operation. As foregoing, fuel efficiency is improved because of the stabilization of combustion. A manufacturing cost of the engine 1 can be held down because the intake control valve 44 according to this embodiment is constructed with an inexpensive butterfly valve whose mechanism is simple. In another embodiment, the intake control valve can be constructed with a simple and inexpensive switch valve which simply opens or closes the main intake passage in an ON-OFF manner or continuously.

More EGR gas is led into the intake passage 54 by the EGR device 5 by increasing an opening of the EGR valve 64 during low or medium load operation of the engine 1. An EGR rate is set high, an amount of intake air flowing inside the auxiliary intake passage 52 increases, and thereby a strong swirl of air charge that is more effective is generated within the combustion chamber. Moreover, in this case, an amount of intake air increases with a constant opening of the throttle valve 34, and thus pumping loss is reduced. Therefore, fuel efficiency is further improved in low or medium load operation of the engine 1.

A pressure inside the exhaust pipe 3a can increase or decrease due to an exhaust pulsation in the engine 1, according to this embodiment. In the case that a pressure inside the exhaust pipe 3a is lower than a pressure inside the venturi tube 71, the reed valve 65 closes, and thereby flow of fresh air into the exhaust pipe 3a inside the EGR device 5 can be prevented. A valve body of the reed valve 65 can be formed into a thin sheet shape, and thus it may deform due to a sharp rise in pressure on a downstream side. However, the EGR valve 64 opens when the pressure in the downstream side of the reed valve 65 sharply rises in the engine 1, according to this embodiment. Therefore, with this engine 1, a pressure of EGR gas is applied to an upstream side of the reed valve 65 and the pressures of the upstream side and the downstream side are balanced, and thereby a deformation of the valve body can be prevented.

Therefore, with the engine 1 according to this embodiment, EGR gas is led into the intake passage (entrance passage 54) over almost the entire operation range of the engine, including high load operation, and fuel efficiency is improved. Also, in low or medium load operation, without using an expensive variable valve timing mechanism, fuel efficiency is improved using the inexpensive intake control valve 44.

Therefore, according to this embodiment, the engine 1 can be produced such that fuel efficiency is improved over the entire operation range and also its manufacturing cost is low.

The engine 1 according to this embodiment is constructed such that fuel is supplied in the theoretical air-fuel ratio over almost the entire operation range. Therefore, with this engine 1, fuel consumption is lowered compared with the engine where an air-fuel ratio is set to a rich side during high load operation.

In the engine 1 according to this embodiment, the EGR valve 64 opens in the cases that an operation state is switched from a low load state to a high load state in a short period, and the engine 1 operating in a low load state stops. Therefore, the EGR valve 64 opens when a large pressure difference occurs between the upstream side and the downstream side of the reed valve 65 and EGR gas is led to the upstream side of the reed valve 65. Thereby, the pressures of the upstream side and the downstream side of the reed valve 65 are balanced. As a result of this, a deformation of the valve body of the reed valve 65 due to the pressure difference can be prevented, and thus the thin, light and inexpensive reed valve 65 that provides good response at high speed can be used as a check valve.

The engine 1, according to the illustrated embodiment, is provided with the two auxiliary intake passages 52 such that they are parallel to each other. Therefore, with this engine 1, intake air flowing out from the auxiliary intake passage 52 (auxiliary intake port 27) can be sent into the combustion chamber through both sides of the valve stem 23a of the intake valve 23. That is, intake air flowing out from the auxiliary intake port 27 flows into the combustion chamber S keeping a high flow speed without being blocked by the valve stem 23a of the intake valve 23. As a result of this, according to this embodiment, a more effective swirl of air charge can be generated inside the cylinder, and fuel efficiency is improved further.

In the embodiment described above, the reed valve 65 functions as a check valve. However, other suitable types of valves, including other types of check valves can be used for the reed valve 65.

Also, in the illustrated embodiment the engine 1 is a V-type eight-cylinder engine. However, the invention(s) disclosed herein can be applied to other types of engines. Additionally, though the engine 1 in the disclosed embodiments utilizes a throttle valve, the engine can utilize other known air-intake control systems (e.g., a variable intake valve control system).

According to at least one of the embodiments disclosed herein, exhaust gas (EGR gas) is drawn from the exhaust gas recirculation device into the venturi tube due at least in part to a pressure difference between an inside of the venturi tube and an inside of the exhaust passage. A pressure is kept negative inside the venturi tube and also in a high load operation where a throttle opening increases.

Therefore, according to the present invention, EGR gas is led into the exhaust passage by the exhaust gas recirculation device in high load operation, and thus the EGR rate is improved. A combustion temperature of the engine decreases because of a high EGR rate. Generally, knocking does not easily occur when the combustion temperature of the engine decreases. A combustion temperature is decreased in this engine at least in part because of the increase in the EGR rate, and thus a compression ratio can be set high while preventing the occurrence of knocking. Therefore, thermal efficiency is high as a result of increasing the compression ratio, and fuel efficiency in high load operation is improved.

Meanwhile, in low or medium load operation, an intake control valve closes, and a swirl of air charge is generated in the cylinder using the auxiliary intake passage. Thereby, combustion can be stabilized. The intake control valve can have a simple and inexpensive switch valve which simply opens or closes the main intake passage in an ON-OFF manner or continuously. Fuel efficiency improves at least in part because combustion is stabilized.

EGR gas is led into the intake passage by the exhaust gas recirculation device in this low or medium operation, and an EGR rate increases. Thereby, an amount of intake air (fresh air+EGR gas) flowing in the auxiliary intake passage increases and a more effective swirl of air charge is generated inside the combustion chamber. Combustion becomes more stable and pumping loss is reduced. Therefore, fuel efficiency is improved further. In the case that a pressure inside the exhaust passage decreases below a pressure inside the venturi tube due to an exhaust pulsation while the engine is operating, a check valve can prevent an inflow of intake air to the exhaust passage. EGR gas is stably mixed into intake air and combustion is stabilized. Therefore, fuel efficiency is improved also.

Therefore, according to at least one embodiment described herein, fuel efficiency can be improved by increasing an EGR rate over almost the entire operation range, including high load operation. In addition, without using an expensive variable valve timing mechanism, fuel efficiency is improved in low or medium load operation using the intake control valve, which can be an inexpensive switch valve.

As a result, fuel efficiency is improved over the entire operation range of the engine, and also an engine that can be produced with a low cost can be provided.

A large pressure difference can occur between the upstream side and the downstream side of the check valve in cases where engine operation is switched from a low-load state to a high-load state in a short period, and the engine operating in a low-load state stops. However, in accordance with at least one embodiment disclosed herein, the exhaust gas recirculation valve opens at this moment and thus EGR gas is led to the upstream side of the check valve. A thin, light, and inexpensive reed valve that has a high-speed response can be used for a check valve, and a production cost can thereby be further reduced. Pressures between the upstream side and the downstream side of the check valve can thus be balanced.

Intake air flowing out from the auxiliary intake passage can be sent into a combustion chamber through both sides of the valve stem of the intake valve. Therefore, intake air flowing out from the auxiliary intake passage is not blocked by the valve stem of the intake valve, and flows into the combustion chamber at a high flow speed. Consequently, a more effective swirl of air charge can be generated in the cylinder, and fuel efficiency is improved further.

Although these inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof. In addition, while a number of variations of the inventions have been shown and described in detail, other modifications, which are within the scope of the inventions, will be readily apparent to those of skill in the art based upon this disclosure. It is also contemplated that various combinations or subcombinations of the specific features and aspects of the embodiments may be made and still fall within one or more of the inventions. Accordingly, it should be understood that various features and aspects of the disclosed embodiments can be combine with or substituted for one another in order to form varying modes of the disclosed inventions. Thus, it is intended that the scope of the present inventions herein disclosed should not be limited by the particular disclosed embodiments described above.

What is claimed is:

1. A spark ignition type multi-cylinder engine, comprising:
an intake device configured to distribute intake air through an entrance passage having a throttle valve to an intake passage of at least one cylinder of the engine; and
an exhaust gas recirculation device configured to recirculate exhaust gas to an intake system via an exhaust gas recirculation valve,
wherein each intake passage of each cylinder comprises a main intake passage connected to a combustion chamber via an intake valve and comprising an intake control valve therein in an upstream position, and a plurality of auxiliary intake passages configured to generate a swirl of air charge inside the combustion chamber, each auxiliary intake passage extending along the main intake passage and having an inlet opening upstream of the intake control valve and an outlet opening at a downstream end thereof proximate the intake valve in the main intake passage, and
a venturi tube disposed on a downstream side of the throttle valve in the entrance passage, an exhaust gas exit of the exhaust gas recirculation device being formed on an internal wall surface of the venturi tube, and a check valve provided between the exhaust gas exit and the exhaust gas recirculation valve.

2. The spark ignition type multi-cylinder engine of claim 1, further comprising a controller configured to control the operation of the exhaust gas recirculation valve, the controller configured to open the exhaust gas recirculation valve where engine operation switches from a low load state to a high load state in a short period, and where the engine operating in a low load state stops.

3. The spark ignition type multi-cylinder engine of claim 1, wherein each cylinder has an intake valve, and the plurality of auxiliary intake passages comprise two auxiliary intake passages directed toward both sides of a valve stem of the intake valve and arranged parallel to each other.

4. The spark ignition type multi-cylinder engine of claim 1, wherein the intake control valve is a butterfly valve.

5. A spark ignition type multi-cylinder engine, comprising:
an intake air conduit configured to distribute intake air to an intake passage of at least one cylinder of the engine, the intake passage comprising a primary intake passage having an intake control valve therein, the primary intake passage in communication with a combustion chamber of the cylinder via an intake valve, the intake passage further comprising at least one auxiliary intake passage configured to generate a swirl of air charge inside the combustion chamber, the auxiliary intake passage having an inlet opening upstream of the intake control valve and an outlet opening proximate the intake valve in the primary intake passage;
an exhaust gas recirculation device configured to recirculate at least a portion of exhaust gas to the intake passage of the at least one cylinder of the engine; and
a venturi tube coupled to the air intake conduit, the exhaust gas recirculation device coupled to the venturi tube via a reed valve disposed between the exhaust gas recirculation device and the venture tube.

6. The engine of claim 5, wherein the at least one auxiliary intake passage comprises two auxiliary intake passages extending generally parallel to each other, each outlet opening of the auxiliary intake passages extending on one side of a valve stem of the intake valve.

7. The engine of claim 5, further comprising a controller configured to control the operation of an exhaust gas recirculation valve disposed between the exhaust gas recirculation device and the reed valve.

8. The engine of claim 5, further comprising a throttle valve disposed in the intake air conduit upstream o fthe venture tube.

9. The engine of claim 8, wherein the throttle valve is a butterfly valve.

10. The engine of claim 5, wherein the reed valve is a check valve.

11. The engine of claim 5, wherein the intake control valve is a butterfly valve.

12. A method for operating a spark ignition type multi-cylinder engine, comprising:
distributing intake air to at least one cylinder of the engine;
recirculating at least a portion of exhaust gas into combination with the intake air directed to the cylinder; and
controlling an exhaust gas recirculation (EGR) valve to control the amount of recirculated exhaust gas directed to the at least one cylinder to obtain an EGR rate in response to an operating state of the engine.

13. The method of claim 12, wherein recirculated exhaust gas flows into the at least one cylinder at least in part due to a pressure difference between an intake passage and an exhaust device.

14. The method of claim 12, wherein the EGR rate is set based on a map stored on a controller for controlling the operation of the EGR valve.

15. The method of claim 12, further comprising opening the EGR valve when operation of the engine switches from a low-load state to a high-load state in a short period of time.

16. The method of claim 12, further comprising generating a swirl of air charge within a combustion chamber of the cylinder with the intake air and recirculated exhaust gas.

17. The method of claim 12, wherein distributing intake air to the at least one cylinder of the engine is done via a throttle valve.

18. The method of claim 17, wherein the throttle valve is a butterfly valve.
